(19) United States
(12) Patent Application Publication
(10) Pub. No.: US 2008/0065621 A1
(43) Pub. Date: Mar. 13, 2008

(54) Ambiguous entity disambiguation method

(76) Inventor: Kenneth Alexander Ellis, Hoboken, NJ (US)

Correspondence Address: ELLIOT FURMAN, 15 WEST 81ST STREET #11J, NEW YORK, NY, 10024, US

(21) Appl. No.: 11/531,360

(22) Filed: Sep. 13, 2006

(51) Int. Cl. G06F 17/30

(52) U.S. Cl. 707/5

(57) ABSTRACT

Ambiguous entities extracted from an article are disambiguated to determine an entity type. Entities are extracted, combined, and entity aliases are created. The entity type is determined by searching a disambiguation database for matching pages in a digital encyclopedia database. A score is computed for each entity and entity alias according to a number of links in the matching pages, and according to a page popularity for the matching pages in the disambiguation database. The highest scoring entity alias is selected and the entity type is the page type of the matching page. Abstracts for the entities may also be retrieved from the matching pages.

This application is related to U.S. patent application Ser. No. 11/463,061 filed Aug. 8, 2006 by Kenneth Alexander Ellis, and entitled “Method for creating a disambiguation database,” the entirety of which is hereby incorporated by reference.

### BACKGROUND

Digital Encyclopedia Databases

Digital encyclopedias have been around for many years. Some of the earliest digital encyclopedias were sold on CD-ROMs to consumers for use on their personal computers. These digital encyclopedias were more easily kept up-to-date than their printed counterparts, and were certainly more convenient. An entire encyclopedia, including all text and images from every volume, could be conveniently stored on a single CD-ROM, and the entire encyclopedia could be easily searched on the personal computer.

With the advent of the Internet, these digital encyclopedias were made available on-line, that is they were stored as a database on an Internet connected computer. In this way, anyone with access to the Internet could search the digital encyclopedia database for items of interest. Additionally, the digital encyclopedia database could be enhanced by linking to resources on other Internet connected computers. Examples of digital encyclopedia databases are Encyclopedia Britannica Online (http://www.britannica.com/) and MSN Encarta (http://encarta.msn.com/). Many other digital encyclopedia databases are available online, some having content of a general nature, and other having highly specialized content in the area of law, medicine, history, and the like.

In recent years, collaboratively written digital encyclopedia databases have grown in popularity, and have become some of the most widely referenced digital encyclopedia databases. A collaboratively written digital encyclopedia is an online digital encyclopedia database contributed to and edited by many people who do necessarily have any connection with each other. For example, the contributors do not necessarily work for the same company or organization, they are not paid for their contributions, and they may not even live in the same country. What they do have in common is an interest in the subject matter they are contributing to in the online digital encyclopedia.

The content of the digital encyclopedia may include text, images, and links to other entries in the digital encyclopedia database as well as to other web pages on the Internet. The content of the digital encyclopedia database is edited by the many contributors to the database. In this way, on average, submissions to the database are kept up to date, unbiased in tone, and factually correct.

One example of a digital encyclopedia database is Wikipedia® (Wikipedia is a registered trademark of the non-profit Wikimedia Foundation) which can be accessed at the web address http://www.wikipedia.org. Wikipedia is just one of many other collaborative database of the Wikimedia Foundation. Just a few examples of other databases include Wiktionary, a multiple language dictionary and thesaurus, Wikiquote, a free compendium of quotations, Wikinews, a collaboratively written news site, and Wikibooks, a collection of open content textbooks. These and other Wikimedia databases are accessible at http://wikimedia.org. Wikimedia is just one example of some of the digital encyclopedia databases available online. Many others are available for free under many licenses and models such as the Creative Commons license and the GNU Free Documentation License (GFDL).

Entity Extraction

Entity extraction, or named entity extraction, refers to information processing methods for extracting information such as names, places, and organizations from machine readable documents. One example of a machine readable document is an on-line article. For example, an on-line article may be a news story available on the Internet from an Internet connected news server.

As is well known, articles are displayed in a web browser on a client computer simply by typing in the web address, referred to more broadly as a universal resource identifier (URI), of any of the news servers. News servers may serve news from thousands of online local, regional, national, and international news outlets supplying news from sources such as Agence France-Press (AFP), Reuters, Associated Press (AP), Los Angeles Times, New York Times, USA Today, National Public Radio (NPR), CNN.com, Slashdot.org. There are many other news servers where Internet users can receive news from, such as Yahoo! News (http://news.yahoo.com) and Google News (http://news.google.com). These and other similar websites sometimes do not generate any original news content, but they aggregate news from a multiplicity of news servers, thus providing a convenient way for Internet users to view articles from a multiplicity of sources from a single website.

An article may be a news article or any other type of article, whether or not it contains current news. The article may comprise aggregated content from a multiplicity of other articles. An article comprises text, with at least some of the text comprising entities. The article may further comprise an image or images, links to audio and video, embedded audio and video, links to other articles, links to web pages and blogs, and the like. As used herein, the term “web browser content” is understood to mean, either by themselves or in combination, text, an image or images, links to audio and video, embedded audio and video, links to other articles, links to web pages and blogs, and other types of content that are displayable or accessible in a web browser.

Entity extraction can be applied to an article to extract entities such as names of people, places, and organization. Dates, time, and numerical quantities such as monetary values may also be extracted. For example, entities in an article on a political subject may include people entities such as the U.S. President, senators, news commentators, and the like. It may also include organization entities such as the Pentagon, the White House, or a corporation such as Halliburton. It may also include places entities such as the United States, Iraq, and Baghdad.

Many well understood linguistic, knowledge-based, statistical, probabilistic, and hybrid methods for entity extraction may be employed, and currently are in prior art implementations. In one embodiment Hidden Markov Models are used. In other embodiments, rule-based methods, machine learning techniques such as Support Vector Machine learning methods, and Conditional Random Fields are implemented either by themselves or in combination.

There are many commercial products available employing these and other techniques, for example IdentiFinder™ from BBN Technologies, products from Basis Technology Corp., Verity Inc., Convera, and Inxight Software Inc.

Freely available software for developing and deploying software components that process human language include GATE (General Architecture for Text Engineering, http://gate.ac.uk), and OpenNLP (http://opennlp.sourceforge.net), which is a collection of open source projects related to natural language processing. These methods, models, algorithms, systems, and products are well understood by those of ordinary skill in the art and are routinely used to extract entities from on-line content such on-line articles, as well as content that is not available on-line such as private databases and files.

Ambiguous Entities

One significant issue facing prior art entity extraction implementations is word sense ambiguity. For example, if the extracted entity is the word “cold”, does “cold” refer to a temperature or a viral infection? Or, if the extracted entity is the word “Bush”, does “Bush” refer to U.S. president George W. Bush, a plant such as a shrub, or Vannevar Bush? (Vannevar Bush was an engineer at the Massachusetts Institute of Technology (MIT) and played an important role in the development of the atomic bomb during World War II. He developed the first modern analog computer, called a Differential Analyzer, which could solve certain classes of differential equations. His work at MIT lead to the development by one of Bush's graduate students, Claude Shannon, of digital circuit design theory.)

Various techniques have been implemented in the prior art to disambiguate entities. Most of these include statistically analyzing the words that surround the extracted entity, and sometimes supervised learning techniques such as Support Vector Machines that require large amounts of training data before they are at all useful. A full survey of disambiguation techniques is disclosed in the paper “Word sense disambiguation: The state of the art”, Ide, N. and Vronis, J. (1998), Computational Linguistics, 241, pp. 1-40, which is hereby incorporated by reference.

The most successful of these and other prior art disambiguation techniques are oftentimes extremely computationally intensive, and the less computationally intensive disambiguation techniques oftentimes provide poor results. It would therefore be advantageous if there were a new way of disambiguating entities that had high accuracy and low computational requirements.

### SUMMARY

The present invention is an ambiguous entity disambiguation method. An article comprises entities and each entity is a single-word or a multi-word entity. At least one entity has an ambiguous meaning. A disambiguation database is provided. The disambiguation database references a digital encyclopedia database. The disambiguation database comprises links to redirect pages of the digital encyclopedia database. The disambiguation database also comprises links to disambiguation pages of the digital encyclopedia database. And, for each redirect page and disambiguation page, the disambiguation database comprises the popularity of the page and the type of the page. Entities are extracted from the article. Multi-word entities are combined, and entity aliases are created for the combined multi-word entities. Next, the disambiguation database is searched for pages in the digital encyclopedia database matching each extracted entity and entity alias. For each matching page, a list of links to other encyclopedia pages is created. Then, a score is computed for each extracted entity and entity alias. The score is based on the list of links and on a popularity stored in the disambiguation database. After, the score is adjusted, the highest scoring entity alias is selected. Thus, the entity type for each entity is the type of matching page for the highest scoring entity alias in the disambiguation database.

The foregoing paragraph has been provided by way of general introduction, and it should not be used to narrow the scope of the following claims. The preferred embodiments will now be described with reference to the attached drawings.

### BRIEF DESCRIPTION OF THE DRAWINGS

FIG. 1 is a method for disambiguating an entity.

FIG. 2 is a prior art method for providing an entity from an article.

FIG. 3 is an ambiguous entity disambiguation method.

FIG. 4 is an ambiguous entity disambiguation method for retrieving an abstract.

### DETAILED DESCRIPTION OF THE PRESENTLY PREFERRED EMBODIMENTS

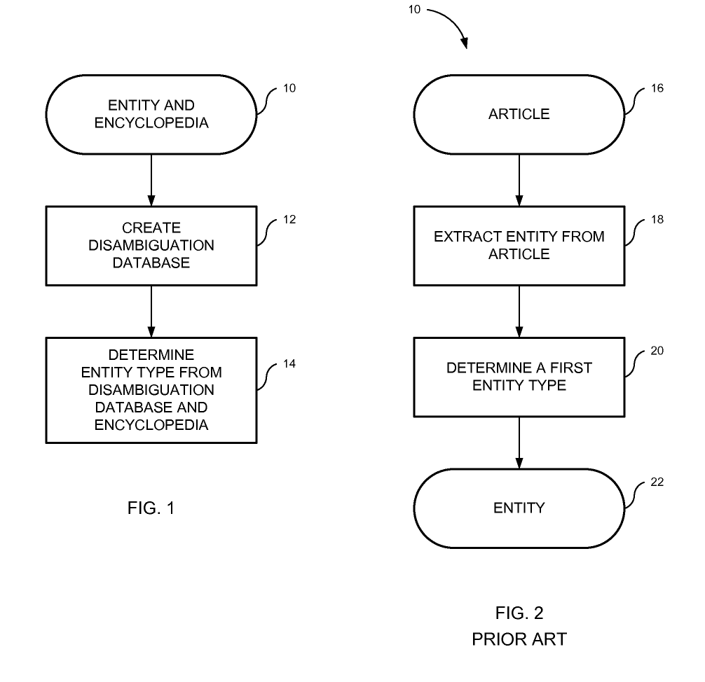

FIG. 1 shows a method for disambiguating an entity. An entity and a digital encyclopedia database are provide 10. A disambiguation database is created (12) and the entity type is determined (14) from the disambiguation database and the encyclopedia. Briefly, the disambiguation database is created from the encyclopedia (10) through a series of simple and quickly computable steps that include simple text searches of the encyclopedia, and performing simple calculations based on a number of links comprising each page in the encyclopedia. Further, the entity type is determined (14) along with a score indicating the likelihood the entity type is correct through a series of simple and quickly performed queries of the disambiguation database and computations involving direct links and indirect links between pages of the encyclopedia. Creating a disambiguation database is disclosed in co-pending U.S. patent application Ser. No. 11/463,061 filed Aug. 8, 2006 by Kenneth Alexander Ellis, and entitled “Method for creating a disambiguation database,” the entirety of which is hereby incorporated by reference.

The following is stored in the disambiguation database: links to redirect pages, links to disambiguation pages, and for each redirect and disambiguation page, the popularity, P, of the page and the page type, which, in one example comprises either a person page or an organization page. Even a very large encyclopedia can easily and quickly be processed to create a disambiguation database. And, as will be disclosed below, the disambiguation database may be accessed to disambiguate entities in an efficient, accurate, and computationally non-intensive manner.

Briefly, the disambiguation database may be queried for extracted ambiguous entities from an article. Direct and indirect links for page matches in the disambiguation database are counted by accessing the pages of the encyclopedia pointed to by the matches. A score is computed from the direct and indirect links, and the score is adjusted according to the popularity P of the matches in the disambiguation database. The entity is then disambiguated, that is a determination is made as to what type of entity it is (for example a person or an organization) according to the score, and type of page matched in the disambiguation database.

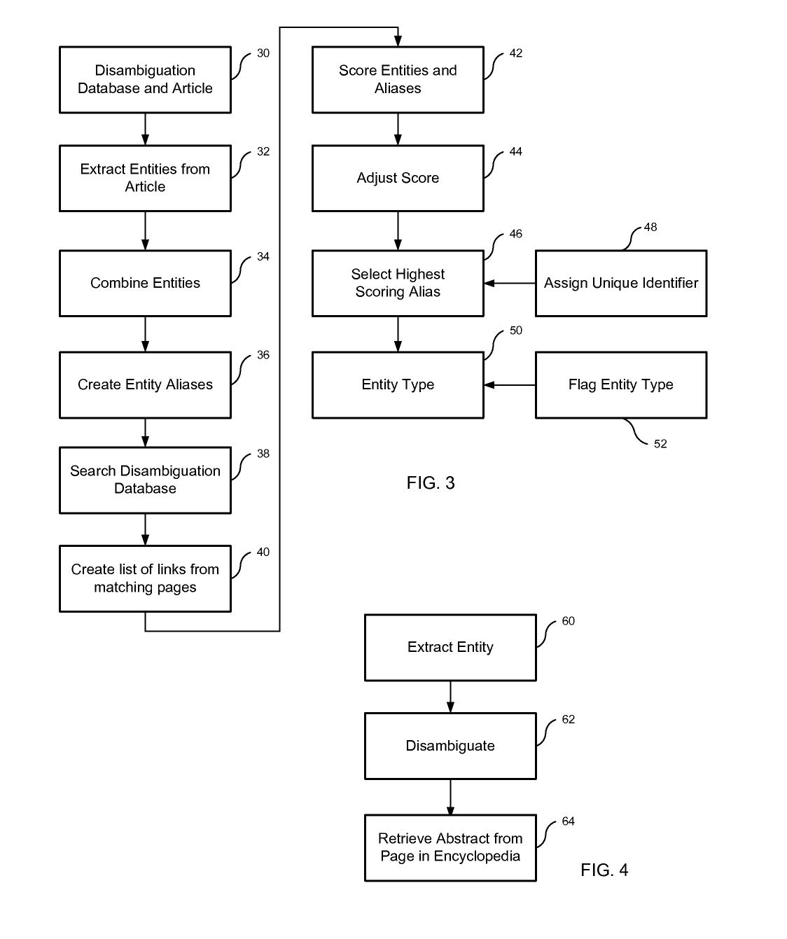

Turning now to FIG. 3, an ambiguous entity disambiguation method is shown. A disambiguation database and an article is provide (step 30). The disambiguation database comprises links to redirect pages and links to disambiguation pages having titles. Also, for each redirect page and disambiguation page, the disambiguation database also includes the popularity of the page and the type of page. In one embodiment the type of the page is a person page or an organization page.

The article comprises entities, at least some of which are ambiguous entities. Each entity is a single-word entity or a multi-word entity. One example of a single-word entity is “Bush”. One example of a multi-word entity is “George Walker Bush”. The multi-word entity comprises the phrase fragments “George Walker” and “Walker Bush”.

Entities are extracted from the article to determine a first entity type. In one embodiment, shown in FIG. 2, a prior art entity extraction method is used. Providing an article (step 16), any one or more than one prior art entity extraction method extracts an entity from the article (step 18) and then makes a first entity determination (step 20), resulting in an entity with a first entity type (step 22). As mentioned, one or more than one prior art method may be used. In one embodiment, a computationally non-intensive but low accuracy prior art entity extraction method is used. This prior art extraction method results in errors, and also result in the same entity having many different forms, for example “George Bush”, “Bush”, and “George W. Bush”. In another embodiment, entities are extracted from the article but a first entity type is not determined.

Next, referring to FIG. 3, entities are combined (step 34) so they are considered the same entity. Combining (step 34) comprises multiple steps.

For each entity, the entity is split into its constituent words. For example, “George Walker Bush” is split into the words “George”, “Walker”, and “Bush”. Next each entity is compared with every other entity that comprise the same or greater number of words. For example, “George Walker Bush” is a three word entity and therefore is only compared against other entities having three or more words.

Next, compared entities are merged, that is, they are considered the same entity, if at least a subset of the their words match and appear in the same order. And, compared entities are merged if the initial letter of each of at least a subset of their words match and appear in the same order. By way of example, for one article, the entity “George Bush” is merged with the entity “George Walker Bush”. By way of another example, the entity “George W. Bush” is merged with “George Walker Bush”, “G. W. Bush”, “G. Bush”, “W. Bush”, “G. W. B.”, “G. Walker Bush”, “Geo. W. Bush”, and the like.

Then a single entity is chosen as representative of the merged entities. The entity chosen is the entity having the longest name. For example, with reference to the preceding example, the single entity chosen is “George Walker Bush” since it is the longest entity. Thus combining (step 34) results in the selection of one representative entity for many entities that are likely the same.

Referring to FIG. 3, following the combining (step 34), entity aliases are created for multi-word entities (step 36). For each entity, a list of aliases is created by forming word sets which have at least two words and preserves their original order. By way of example, the multi-word entity “President George W. Bush” has the aliases “President George”, “President W.”, “President Bush”, “George W.”, “George Bush”, “President George W.”, “President George Bush,” and “George W. Bush”.

Next, the disambiguation database is searched (step 38) for any disambiguation pages matching each extracted entity and entity alias. The search is case insensitive. If a matching page is a redirect page, then the page to which it redirects is followed and all of the outbound links from the followed redirect page are considered a match. If the matching page is a disambiguation page, then all of the outbound links from the matching disambiguation page are considered a match. Then, for each link considered a match, a list of links to other pages to which the matching page links is created (step 40).

Continuing, each entity and alias is scored (step 42). The score is computed based on the number of direct links and indirect links to matching pages for other entities and aliases. For example, “George Bush” and “White House” are aliases for different entities. In this example, assume both entities have one direct link to each other, that is the “George Bush” entity page links to the “White House” entity page exactly one time. Also assume both entities have fifty links to a separate third page, that is the entities links to each other fifty times, indirectly through the separate third page. For example, the third page may be a “Pentagon” entity page, even if “Pentagon” is not one of the extracted entities.

So, the score for a for an entity or alias pointing to a page A is computed as follows:
a) Direct Link Points=LP1=5* No. of direct links between pages A and B
b) Indirect Link Points=LP2=2* No. of indirect links between pages A and B
c) Score(A,B)=LP1/LT_{A}+LP1/LTB_{B}+LP2/sqrt(LT_{A}̂2+LT_{B}̂2) where LT_{N}=total number of inbound and outbound links of page N
d) Score(A)=P_{A} * SUM(Score(A,N) for all N !=A) where P_{A}=Popularity of Page A from disambiguation database

Then the score is adjusted (step 44) according to whether the title of the matching page and entity name are an exact match. For example, the score is adjusted if both the entity name and the matching page name is “George W. Bush”. In one embodiment the score is adjusted as follows: Score(A)=Score(A)* 20.

Next, the highest scoring alias is selected (step 46). Therefore, the highest scoring alias is the representative name of the entity, and the matching page referenced by the alias is the representative page of the entity. Also, a unique identifier may optionally be assigned to the to selected alias (step 48). For example “George Walker Bush” may have an identifier 56700231. Thus any extracted entities named “George Walker Bush” are referenced to this identifier. So, later, if a better name (higher scoring) for the entity is found, for example “President George W. Bush”, the name can be changed while maintaining the referenced page.

So, as disclosed, a single page in the encyclopedia is found for each extracted entity by way of the disambiguation database. Since each entity can now reference exactly one encyclopedia page, the entity type is determined by checking the page type of encyclopedia page as stored in the disambiguation database (step 50). In one example, the page type is either a person page, or an organization page.

In one more example, “George Bush” is extracted as an entity in an article. The encyclopedia page, for example a disambiguation page, shows several names with links to corresponding pages, including “George W. Bush”, “George H. W. Bush”, “George P. Bush”, and “George Bush (musician)”. Other extracted entities of the article include “The Pentagon”, “White House”, and “Tony Blair”. The pages “George W. Bush” and “George H. W. Bush” have a high popularity score according to the disambiguation database, and they have a multiplicity of links to other entities. However neither page is an exact match for “George Bush”. “George Bush” the musician however is an exact match, but is has a low popularity and no links with the other extracted entities “The Pentagon”, “White House”, and “Tony Blair”. Thus, according to the methods disclosed above, because “George W. Bush” has links to “Tony Blair” as well as to the other entities, “George W. Bush” will have the highest score and the encyclopedia page for the president “George W. Bush” will be selected as the actual entity in the article.

Modifications may be made to the above disclosed methods. For example the correctness of entity type of step 50 can be reinforced (step 52). In this embodiment, a first entity type is determined in step 32 and the entity type of step 50 is compared with the first entity type. If first entity type of step 32 and the entity type of step 50 match then the entity type of step 50 is flagged. The flag indicates that the entity type has a very high reliability of being correct.

In another embodiment shown in FIG. 4, an ambiguous entity disambiguation method for retrieving an abstract is shown. As described above, an entity is extracted (step 60). Next the entity is disambiguated (step 62) as described with reference to FIG. 3. As disclosed, in disambiguating the entity, an entity type is determined and a page of the encyclopedia is determined. Once disambiguated, the abstract, a brief description, or other information describing the entity can be retrieved (step 64) from the final matching page for the entity.

In an embodiment, after disambiguation (step 62) a record is created of the matching disambiguation database entry of the entity so that, at a later time, the abstract, brief description, or other information can be retrieved (step 64) from the matching encyclopedia page by simply referencing the record, rather than having to repeat the steps of disambiguation (step 62).

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

What is claimed is:

1. An ambiguous entity disambiguation method, wherein an article comprises entities and each entity is a single-word or a multi-word entity, wherein at least one entity has an ambiguous meaning, the method comprising the steps of:
providing a disambiguation database which references a digital encyclopedia database, the disambiguation database comprising links to redirect pages of the digital encyclopedia database, links to disambiguation pages of the digital encyclopedia database, and for each redirect page and disambiguation page, the popularity of the page and the type of page;
extracting entities from the article;
combining multi-word entities;
creating entity aliases for combined multi-word entities;
searching the disambiguation database for pages in the digital encyclopedia database matching each extracted entity and entity alias;
for each matching page, creating a list of links to other encyclopedia pages;
scoring each extracted entity and entity alias according to the list of links and disambiguation database;
adjusting each of the scores; and
for each entity, selecting the highest scoring entity alias;
whereby the entity type for each entity is the type of matching page for the highest scoring entity alias in the disambiguation database.

2. The method of claim 1 wherein said extracting entities includes determining a first extracted entity type.

3. The method of claim 2 wherein said selecting the highest scoring entity alias includes, for each entity, comparing the entity type with the first extracted entity type, and flagging the entity type if said comparing results in a match.

4. The method of claim 1 further comprising retrieving an abstract from the matching page of the highest scoring entity alias.

5. The method of claim 1 wherein said step of creating entity aliases comprises creating a list of all word sets having at least two words in common and in the same original order.

6. The method of claim 1 wherein said step of creating a list of links comprises, if the matching page is a redirect page, retrieving from a page pointed to by the redirect page.

7. The method of claim 1 wherein said step of searching the disambiguation database comprises executing a case-insensitive search.

8. The method of claim 1 wherein said step of scoring comprises computing a score according to a number of links.

9. The method of claim 8 wherein said step of scoring comprises computing a score according to a according to a page popularity.

10. The method of claim 1 wherein said step of adjusting the score comprises comparing the entity name and the matching page name.

11. An ambiguous entity disambiguation method for an entity in an article, the method comprising:
providing a digital encyclopedia database;
creating a disambiguation database from the digital encyclopedia database; and
determining the entity type of the entity in the article from the disambiguation database and digital encyclopedia database.

12. The method of claim 11 wherein said determining comprising searching for the entity in the disambiguation database to identify matching pages in the encyclopedia database, and computing a score for the entity.

13. The method of claim 12 wherein said computing comprises computing according to a number of links in the matching pages.

14. The method of claim 13 wherein said computing further comprises computing according to a popularity of the matching pages.

15. The method of claim 12 further comprising adjusting the score for the entity if the entity and a title of the matching pages are identical.

16. A computer program product for ambiguous entity disambiguation, wherein an article comprises entities and each entity is a single-word or a multi-word entity, wherein at least one entity has an ambiguous meaning, the program product comprising:
a computer readable medium;
disambiguation database means stored on said computer readable medium for providing a disambiguation database which references a digital encyclopedia database, the disambiguation database comprising links to redirect pages of the digital encyclopedia database, links to disambiguation pages of the digital encyclopedia database, and for each redirect page and disambiguation page, the popularity of the page and the type of page;
extracting entities means stored on said computer readable medium for extracting entities from the article;
combining means stored on said computer readable medium for combining multi-word entities;
creating means stored on said computer readable medium for creating entity aliases for combined multi-word entities;
searching means stored on said computer readable medium for searching the disambiguation database for pages in the digital encyclopedia database matching each extracted entity and entity alias;
creating means stored on said computer readable medium for creating a list of links for each matching page to other encyclopedia pages;
scoring means stored on said computer readable medium for scoring each extracted entity and entity alias according to the list of links and disambiguation database;
adjusting means stored on said computer readable medium for adjusting each of the scores; and
selecting means stored on said computer readable medium for selecting the highest scoring entity alias for each entity.
